(19) United States
(12) Patent Application Publication
(10) Pub. No.: US 2024/0242858 A1
(43) Pub. Date: Jul. 18, 2024

(54) Cable Clamping Device

(71) Applicants: TE Connectivity Solutions GmbH, Schaffhausen (CH); Tyco Electronics (Shanghai) Co., Ltd., Shanghai (CN)

(72) Inventors: An (Joshua) Yang, Shanghai (CN); Lvhai (Samuel) Hu, Shanghai (CN); Roberto Francisco-Yi Lu, Bellevue, WA (US)

(73) Assignees: TE Connectivity Solutions GmbH, Schaffhausen (CH); Tyco Electronics (Shanghai) Co., Ltd., Shanghai (CN)

(21) Appl. No.: 18/414,576

(22) Filed: Jan. 17, 2024

(30) Foreign Application Priority Data
Jan. 18, 2023 (CN) 202310085674.5

(51) Int. Cl. H01B 13/00

(52) U.S. Cl. CPC H01B 13/0036

(57) ABSTRACT

A cable clamping device includes a first clamping device having a first fixture for clamping a cable and a second clamping device having a second fixture for clamping the cable. The first fixture clamps at a predetermined location on the cable. The cable has an extension section extending a predetermined length forward from the first fixture. The second fixture clamps on the extension section of the cable to align the extension section of the cable with a cable processing module.

### CROSS-REFERENCE TO RELATED APPLICATIONS

This application claims the benefit of the filing date under 35 U.S.C. § 119(a)-(d) of Chinese patent application Ser. No. 202310085674.5, filed on Jan. 18, 2023.

### FIELD OF THE INVENTION

The present invention relates to a cable clamping device for clamping a cable.

### BACKGROUND

In the prior art, before using a cable processing device to process an end of a cable, it is necessary to use a cable clamping device to clamp and secure the cable. Usually, the clamped cable has an extension section with a predetermined length extending forward from the fixture of the cable clamping device, and the cable processing device is used to process the extension section of the cable. However, in the prior art, it is difficult to ensure that the extension section of the cable is aligned with the cable processing device, especially when the cable is relatively soft, which makes the processing of the cable difficult and seriously affects the processing efficiency and quality of the cable end.

### SUMMARY

A cable clamping device includes a first clamping device having a first fixture for clamping a cable and a second clamping device having a second fixture for clamping the cable. The first fixture clamps at a predetermined location on the cable. The cable has an extension section extending a predetermined length forward from the first fixture. The second fixture clamps on the extension section of the cable to align the extension section of the cable with a cable processing module.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a first clamping device according to an exemplary embodiment of the present invention;

FIG. 2 shows an illustrative perspective view of the first and second clamping devices according to an exemplary embodiment of the present invention when viewed from the front side;

FIG. 3 shows an illustrative perspective view of the first and second clamping devices according to an exemplary embodiment of the present invention when viewed from the rear;

FIG. 4 shows an illustrative perspective view of the second clamping device according to an exemplary embodiment of the present invention when viewed from the front side; and

FIG. 5 shows an illustrative perspective view of the second clamping device according to an exemplary embodiment of the present invention when viewed from the rear.

### DETAILED DESCRIPTION OF EXEMPLARY EMBODIMENTS

Exemplary embodiments of the present disclosure will be described hereinafter in detail with reference to the attached drawings, wherein like reference numerals refer to like elements. The present disclosure may however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

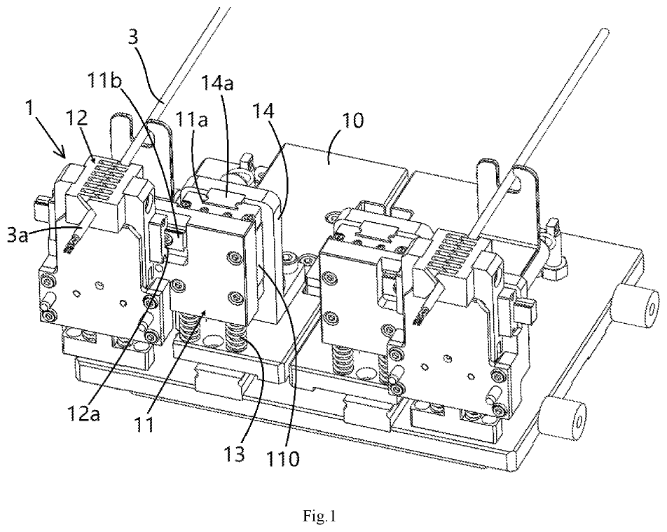

As shown in FIGS. 1 to 5, in an exemplary embodiment of the present invention, a cable clamping device is disclosed. The cable clamping device includes a first clamping device 1 and a second clamping device 2. The first clamping device 1 includes a first fixture 12 for clamping the cable 3. The second clamping device 2 includes a second fixture 22 for clamping the cable 3.

The first fixture 12 is used to clamp the cable 3 at a predetermined location, so that the clamped cable 3 has an extension section 3a extending a predetermined length forward from the first fixture 12. The second fixture 22 is used to clamp on the extension section 3a of cable 3 to ensure that the end of the extension section 3a of cable 3 is aligned with the cable processing module. The alignment facilitates processing of the end of the cable 3, greatly improving the processing efficiency and quality of the cable end.

As shown in FIGS. 1 to 5, in the illustrated embodiment, the first clamping device 1 and the second clamping device 2 are two independent clamping devices separated from each other. Therefore, the second clamping device 2 will not affect the operation of the first clamping device 1, and the first clamping device 1 will not affect the operation of the second clamping device 2. This can improve the flexibility of the entire cable clamping device. In addition, in the illustrated embodiment, the first fixture 12 and the second fixture 22 can move synchronously to ensure that the first fixture 12 and the second fixture 22 are always aligned with each other.

As shown in FIG. 1, in the illustrated embodiment, the first clamping device 1 further includes: a first horizontal support seat 10, a first elastic member 13, and a first floatable frame 11. The first elastic member 13 is arranged on the first horizontal support seat 10. The first floatable frame 11 is supported on the first elastic member 13 and can float in a vertical direction relative to the first horizontal support seat 10. The first fixture 12 is movably installed on the first floatable frame 11 and can move in a horizontal direction relative to the first floatable frame 11. In the illustrated embodiment, the first elastic member 13 can be a helical spring.

As shown in FIG. 1, in the illustrated embodiment, the first clamping device 1 further includes a first vertical bracket 14, which is fixed to the first horizontal support seat 10. One of the first floatable frame 11 and the first vertical support 14 is provided with a first vertical sliding groove 11a, and the other is provided with a first vertical slide rail 14a that matches the first vertical sliding groove 11a. The first vertical slide groove 11a is matched with the first vertical slide rail 14a to guide the first floatable frame 11 to float in the vertical direction relative to the first horizontal support seat 10.

In the illustrated embodiment, a first sliding block 110 is fixed on the first floatable frame 11, and the first vertical slide groove 11a is formed on the first sliding block 110. The first vertical slide rail 14a is fixed to the first vertical bracket 14 and mated with the first vertical slide groove 11a on the first sliding block 110.

As shown in FIG. 1, in the illustrated embodiments, one of the first floatable frame 11 and the first fixture 12 is provided with a first horizontal slide groove 12a, and the other is provided with a first horizontal slide rail 11b that matches the first horizontal slide groove 12a. The first horizontal slide groove 12a is matched with the first horizontal slide rail 11b to guide the first fixture 12 to move in the horizontal direction relative to the first floatable frame 11.

In the illustrated embodiment, the first clamping device 1 further includes a first horizontal driving device, which is installed on the first floatable frame 11 and connected to the first fixture 12 to drive the first fixture 12 to move horizontally relative to the first floatable frame 11. The first horizontal driving device can be an air cylinder or an electric cylinder.

In an embodiment, the cable clamping device further includes a vertical pressing device, which is used to press the first floatable frame 11 to drive it to float in the vertical direction.

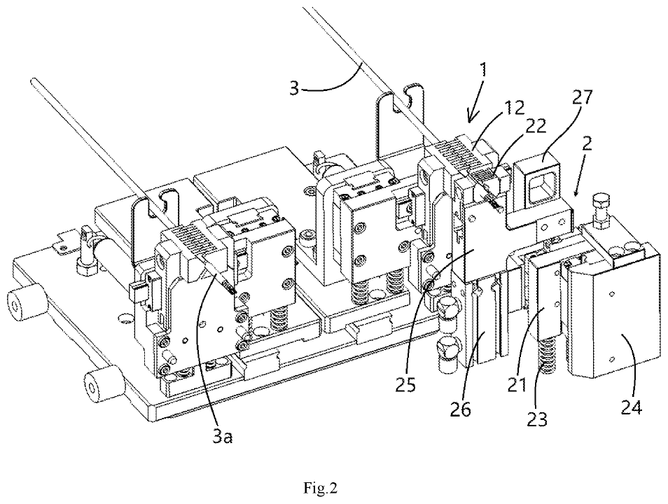

As shown in FIGS. 2, 4, and 5, in the illustrated embodiment, the second clamping device 2 further includes a second horizontal support seat, a second elastic member 23, and a second floatable frame 21. The second elastic member 23 is arranged on the second horizontal support seat. The second floatable frame 21 is supported on the second elastic member 23 and can float in the vertical direction relative to the second horizontal support seat. The second fixture 22 is movably installed on the second floatable frame 21 and can move horizontally relative to the second floatable frame 21. In the illustrated embodiment, the second elastic member 23 can be a helical spring.

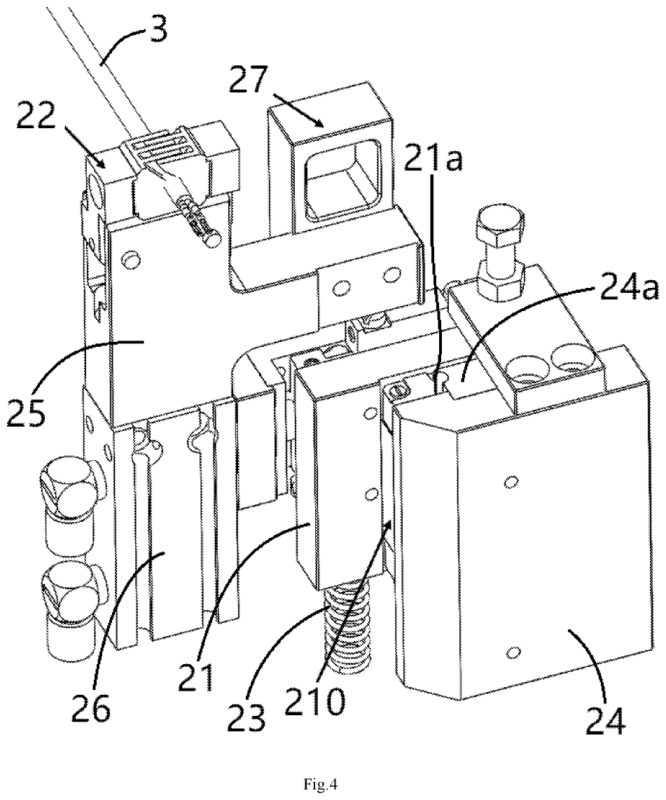

As shown in FIGS. 2, 4, and 5, in the illustrated embodiment, the second clamping device 2 further includes a second vertical bracket 24, which is fixed to the second horizontal support seat. One of the second floatable frame 21 and the second vertical support 24 is provided with a second vertical sliding groove 21a, and the other is provided with a second vertical slide rail 24a that is mated with the second vertical sliding groove 21a, as shown in FIG. 4. The second vertical slide groove 21a is matched with the second vertical slide rail 24a to guide the second floatable frame 21 to float in the vertical direction relative to the second horizontal support seat.

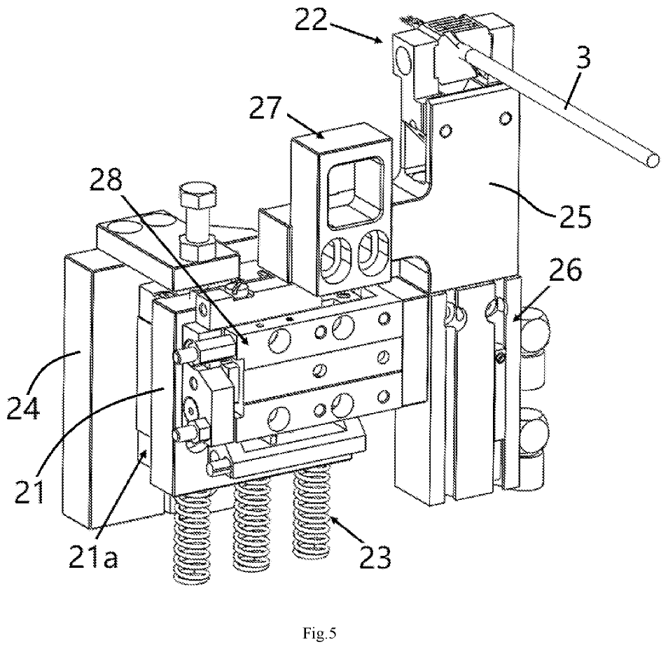

In the illustrated embodiment, a second sliding block 210 is fixed on the second floatable frame 21, as shown in FIG. 5, and the second vertical slide groove 21a is formed on the second sliding block 210. The second vertical slide rail 24a is fixed to the second vertical bracket 24 and mated with the second vertical slide groove 21a on the second sliding block 210.

As shown in FIGS. 2, 4, and 5, in the illustrated embodiment, the second clamping device 2 further includes a pressing block 27, which is fixed to the top of the second floatable frame 21, thereby driving the second floatable frame 21 to float vertically by pressing the pressing block 27.

In an embodiment, the cable clamping device further includes a vertical pressing device, which is suitable for simultaneously pressing on the first floatable frame 11 and the pressing block 27 to drive the first floatable frame 11 and the second floatable frame 21 to float synchronously in the vertical direction.

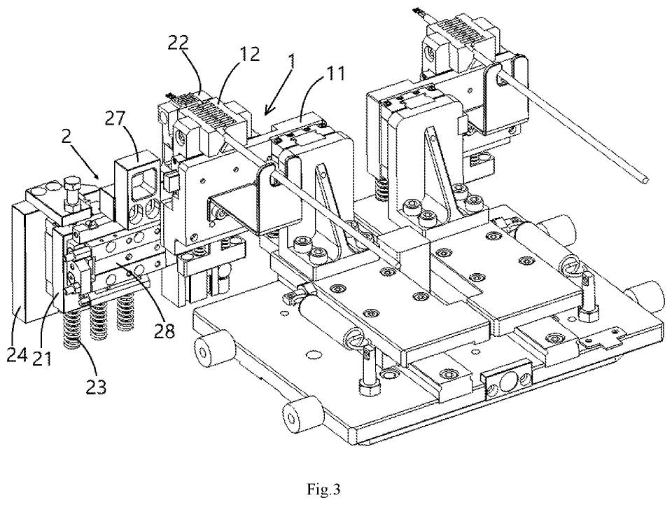

As shown in FIGS. 2 and 3, in the illustrated embodiment, the second clamping device 2 further includes a horizontal moving frame 25 and a second horizontal driving device 28. The horizontal moving frame 25 can move in a horizontal direction relative to the second floatable frame 21. The second horizontal driving device 28 is installed on the second floatable frame 21 and connected to the horizontal moving frame 25, for driving the horizontal moving frame 25 to move in the horizontal direction. The second fixture 22 is installed on the horizontal moving frame 25 to move horizontally with the horizontal moving frame 25. In the illustrated embodiment, the second horizontal driving device 28 can be an air cylinder or an electric cylinder.

In an exemplary embodiment of the present invention, a second horizontal slide groove is provided on one of the horizontal moving frame 25 and the pressing block 27, and a second horizontal slide rail is provided on the other to guide the horizontal moving frame 25 to move horizontally relative to the second floatable frame 21.

In another exemplary embodiment of the present invention, a second horizontal slide groove is provided on one of the horizontal moving frame 25 and the second floatable frame 21, and a second horizontal slide rail is provided on the other to guide the horizontal moving frame 25 to move horizontally relative to the second floatable frame 21.

As shown in FIGS. 2, 4, and 5, in the illustrated embodiment, the second clamping device 2 further includes a driving device 26, which is installed on the horizontal moving frame 25 to drive the second clamping device 22 to open and close, in order to loosen or clamp the extension section 3a of the cable 3. In the illustrated embodiment, the driving device 26 can be an air cylinder or an electric cylinder.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A cable clamping device, comprising:
a first clamping device having a first fixture for clamping a cable, the first fixture clamps at a predetermined location on the cable, the cable has an extension section extending a predetermined length forward from the first fixture; and
a second clamping device having a second fixture for clamping the cable, the second fixture clamps on the extension section of the cable to align the extension section of the cable with a cable processing module.

2. The cable clamping device of claim 1, wherein the first clamping device and the second clamping device are independent and separated from each other.

3. The cable clamping device of claim 2, wherein the first fixture and the second fixture move synchronously to ensure that the first fixture and the second fixture remain aligned with each other.

4. The cable clamping device of claim 3, wherein the first clamping device includes a first horizontal support seat, a first elastic member arranged on the first horizontal support seat, and a first floatable frame supported on the first elastic member and floatable in a vertical direction relative to the first horizontal support seat, the first fixture is movably installed on the first floatable frame and is movable in a horizontal direction relative to the first floatable frame.

5. The cable clamping device of claim 4, wherein the first clamping device includes a first vertical bracket fixed to the first horizontal support seat, a first vertical slide groove is arranged on one of the first floatable frame and the first vertical bracket, a first vertical slide rail that matches the first vertical slide groove is arranged on the other of the first floatable frame and the first vertical bracket, the first vertical slide groove is matched with the first vertical slide rail to guide the first floatable frame to float in the vertical direction relative to the first horizontal support seat.

6. The cable clamping device of claim 5, wherein a first sliding block is fixed on the first floatable frame, and the first vertical slide groove is formed on the first sliding block, the first vertical slide rail is fixed to the first vertical bracket and mated with the first vertical slide groove on the first sliding block.

7. The cable clamping device of claim 5, wherein one of the first floatable frame and the first fixture has a first horizontal slide groove, and the other of the first floatable frame and the first fixture has a first horizontal slide rail that matches the first horizontal slide groove, the first horizontal slide groove is matched with the first horizontal slide rail to guide the first fixture to move in the horizontal direction relative to the first floatable frame.

8. The cable clamping device of claim 6, wherein the first clamping device includes a first horizontal driving device installed on the first floatable frame and connected to the first fixture, the first horizontal driving device driving the first fixture to move in the horizontal direction relative to the first floatable frame.

9. The cable clamping device of claim 4, further comprising a vertical pressing device pressing the first floatable frame to drive the first floatable frame to float in the vertical direction.

10. The cable clamping device of claim 1, wherein the second clamping device includes a second horizontal support seat, a second elastic member arranged on the second horizontal support seat, and a second floatable frame supported on the second elastic member and floatable in a vertical direction relative to the second horizontal support seat, the second fixture is movably installed on the second floatable frame and movable in a horizontal direction relative to the second floatable frame.

11. The cable clamping device of claim 10, wherein the second clamping device includes a second vertical bracket fixed to the second horizontal support seat, a second vertical slide groove on one of the second floatable frame and the second vertical bracket, and a second vertical slide rail is provided on the other of the second floatable frame and the second vertical bracket that mates with the second vertical slide groove.

12. The cable clamping device of claim 11, wherein the second vertical slide groove is matched with the second vertical slide rail to guide the second floatable frame to float in the vertical direction relative to the second horizontal support seat.

13. The cable clamping device of claim 12, wherein a second sliding block is fixed on the second floatable frame, the second vertical slide groove is formed on the second sliding block, the second vertical slide rail is fixed to the second vertical bracket and mated with the second vertical slide groove on the second sliding block.

14. The cable clamping device of claim 10, wherein the second clamping device includes a pressing block fixed to a top of the second floatable frame, the second floatable frame is drivable to float in the vertical direction by pressing the pressing block.

15. The cable clamping device of claim 14, further comprising a vertical pressing device simultaneously pressing on a first floatable frame and the pressing block to drive the first floatable frame and the second floatable frame to float synchronously in the vertical direction.

16. The cable clamping device of claim 14, wherein the second clamping device includes a horizontal moving frame movable in the horizontal direction relative to the second floatable frame, and a second horizontal driving device installed on the second floatable frame and connected to the horizontal moving frame, the second horizontal driving device driving the horizontal moving frame to move in the horizontal direction.

17. The cable clamping device of claim 16, wherein the second fixture is installed on the horizontal moving frame to be movable along the horizontal direction with the horizontal moving frame.

18. The cable clamping device of claim 17, wherein a second horizontal slide groove is arranged on one of the horizontal moving frame and the pressing block, a second horizontal slide rail is provided on the other of the horizontal moving frame and the pressing block, the second horizontal slide rail is matched with the second horizontal slide groove to guide the horizontal moving frame to move in the horizontal direction relative to the second floatable frame.

19. The cable clamping device of claim 17, wherein a second horizontal slide groove is arranged on one of the horizontal moving frame and the second floatable frame, a second horizontal slide rail is provided on the other of the horizontal moving frame and the second floatable frame, the second horizontal slide rail is matched with the second horizontal slide groove to guide the horizontal moving frame to move in the horizontal direction relative to the second floatable frame.

20. The cable clamping device of claim 17, wherein the second clamping device includes a driving device installed on the horizontal moving frame and driving the second fixture to open and close, loosening or clamping the extension section of the cable.
